(19) United States
(12) Patent Application Publication
(10) Pub. No.: US 2024/0211775 A1
(43) Pub. Date: Jun. 27, 2024

(54) COMMUNICATION NETWORK

(71) Applicant: Nokia Technologies Oy, Espoo (FI)

(72) Inventors: Stephen MWANJE, Munich (DE); Abdelrahman ABDELKADER, Munich (DE)

(21) Appl. No.: 18/496,287

(22) Filed: Oct. 27, 2023

(30) Foreign Application Priority Data
Nov. 2, 2022 (GB) 2216263.0

(51) Int. Cl. G06N 5/022

(52) U.S. Cl. CPC G06N 5/022

(57) ABSTRACT

A management service producer or data repository of a communication network provides at least one of the following: information about knowledge available for sharing, or knowledge available for sharing, and executes a transfer learning process for sharing at least part of the knowledge. A management service consumer of the communication network generates at least one of the following: a request for information on available knowledge from the management service producer or data repository, a request for available knowledge from the management service producer or data repository, or a request for executing a transfer learning process between the management service producer or data repository and an ML entity or ML-enabled function of the communication network, and

manages the request for available knowledge or the request for executing the transfer learning process, and/or adapts content of the request for available knowledge or the request for executing the transfer learning process.

### CROSS-REFERENCE TO RELATED APPLICATIONS

This application claims the benefit of priority of United Kingdom Patent Application No. 2216263.0 filed Nov. 2, 2022, which is hereby incorporated by reference as if reproduced in its entirety.

### TECHNICAL FIELD

At least some example embodiments of the subject matter described herein relate to a communication network, e.g. a mobile communication network, using Artificial Intelligence (AI) and Machine Learning (ML) techniques.

### BACKGROUND

Cognitive Autonomous Networks (CAN) promise to provide intelligence and autonomy in network Operations, Administration and Management (OAM) as well as in the network procedures to support the increased flexibility and complexity of the radio network. Through use of Machine Learning (ML) and Artificial Intelligence (AI) in the Cognitive Functions, CAN will be able to:
1) take higher level goals and derive the appropriate performance targets,
2) learn from their environment and their individual or shared experiences therein,
3) learn to contextualize their operating conditions, and
4) learn their optimal behavior fitting to the specific environment and contexts.

One use case for such cognitive automation is handover optimization.

Cognition (and CAN as described above) is expected to be achieved through the use of Artificial Intelligence (AI) and Machine Learning (ML) implemented in both the network and management functions for undertaking analytics and decisions on different network aspects. 3GPP SA5 and SA2 are both standardizing AI/ML capabilities intended to support production of analytics insight and decisions.

Reference [1] specifies the Artificial Intelligence/Machine Learning (AI/ML) management capabilities and services for 5GS where AI/ML is used. It also describes the functionality and service framework for AI/ML management. Based on the service-based management architecture, an AI/ML-enabled function has or is related to a producer of AI/ML Management services (also called the AI/ML MnS producer) which provides services that are consumed by one or more consumers of AI/ML Management services (also called the AI/ML MnS consumers).

### LIST OF ABBREVIATIONS

3GPP Third Generation Partnership Project

5G Fifth Generation

5GS 5G System

AI Artificial Intelligence

AMF Access and Mobility Management Function

CAN Cognitive Autonomous Network

CDF Cumulative Distribution Function

CM Conditional-Mandatory

DSON Distributed SON

F False

gNB 5G NodeB

IOC Information Object Class

M Mandatory

ML Machine Learning

MnS Management Service

MOI Managed Object Instance

NWDAF Network Data Analytics Function

Optional

OAM Operations, Administration and Management

PDF Probability Density Function

RAN Radio Access Network

SON Self-Organizing Network

T True

TL Transfer Learning

TR Technical Report

TS Technical Specification

### LIST OF REFERENCES

[1] 3GPP TS 28.105 version 17.1.1

### SUMMARY

An MLEntity (also referred to as ML entity) is an entity or artefact that contains at least an ML model with meta data about that ML model and that can be managed as a single composite entity. Developing and deploying new MLEntities is not an easy task. It requires time as well as a huge amount of data with high computational consumption in order to design, train, validate and test solutions before deployment. However, sometimes the knowledge contained in deployed MLEntities can, when reapplied, significantly reduce the effort of developing new MLEntities. This depends at least on the amount of domain and task similarity between MLEntities producing (source) and consuming (target) MLTL MnS. As the amount of similarity increases, so does the relevant shareable knowledge between the two MLEntities.

Current communication systems (be it in management or the control and data planes in the core network or the RAN) do not provide means to support Transfer Learning.

According to at least some example embodiments of the subject matter described herein:
Means are provided for a given consumer to request for available shared knowledge related to a specific domain, task, context or given network problem.
Means are provided for a given consumer to request an MLEntity to adapt existing shared knowledge to a new domain, task, context or given network problem.
Means are provided for a given MLEntity to report on available shared knowledge on a specific domain, task, context or given network problem.

Moreover, according to at least some example embodiments of the subject matter described herein, a form of centralized knowledge repository for sharing knowledge through transfer learning is provided. At this centralized knowledge repository, MLEntities can register available knowledge and authorized consumers may search for existing shared knowledge according to some meta description of domain, task, or context.

According to at least some example embodiments of the subject matter described herein, means and capabilities for such transfer learning between MLEntities or functions containing MLEntities as well as functionality for supporting a centralized knowledge repository and corresponding interfaces and services are provided.

At least some example embodiments of the subject matter described herein aim at providing a general functionality for knowledge sharing to enable transfer learning between any two MLEntities. This is achieved by the methods, apparatuses and non-transitory computer-readable storage media as specified by the appended claims.

In the following, example embodiments will be described with reference to the accompanying drawings.

### BRIEF DESCRIPTION OF THE DRAWINGS

FIG. 1 shows a schematic block diagram illustrating use, management and control of MLTL between an MLTL MnS Consumer and an MLTL MnS producer according to at least some example embodiments.

FIG. 2 shows a schematic block diagram illustrating use, management and control of MLTL between an MLTL MnS producer and an MLTL recipient which is not an MnS Consumer, according to at least some example embodiments.

FIG. 3 shows a schematic block diagram illustrating use, management and control of MLTL between two MLEntities and a data repository (e.g. knowledge repository, MLTL repository) according to at least some example embodiments.

FIGS. 4A and 4B show flowcharts illustrating processes for use, management and control of a transfer learning process (e.g. MLTL) according to at least some example embodiments.

FIG. 5 shows a signalling diagram illustrating signalling for discovering shared knowledge according to at least some example embodiments.

FIG. 6 shows a signalling diagram illustrating signalling for requesting and receiving shared knowledge according to at least some example embodiments.

FIG. 7 shows a signalling diagram illustrating signalling for triggering transfer learning on an MLTL MnS Producer or on an MLTLRecipient function according to at least some example embodiments.

FIG. 8 shows a schematic diagram illustrating an Information Model for ML Knowledge sharing and Transfer Learning according to at least some example embodiments.

FIG. 9 shows a schematic diagram illustrating MLTL Inheritance Relations for ML Knowledge sharing and Transfer Learning according to at least some example embodiments.

FIG. 10 shows a signalling diagram illustrating signalling for discovering shared knowledge according to an implementation example of the subject matter described herein.

FIGS. 11A and 11B show a schematic block diagrams illustrating apparatuses in which example embodiments are implementable.

### DESCRIPTION OF THE EMBODIMENTS

Before giving a description of example embodiments and an implementation example of the subject matter described herein, some terms and definitions used herein will be described:
An MLEntity (also referred to as ML entity) is an entity or artefact that contains at least an ML model with meta data about that ML model and that can be managed as a single composite entity. The ML model may be a mathematical function that can be trained by an expert using data to learn to compute specific predictions. The MLEntity may be also called an MLApp, but the term MLEntity is used to refer to any of these variations of artefacts capable of making predictions using ML logic.
An ML-enabled function (e.g. an AI/ML-enabled function) may be any network-related function that applies AI/ML to accomplish an objective of the network-related function. The AI/ML-enabled function may contain one or several MLEntities and examples of network-related functions include:
   management functions like Management data analytics function or Self-organizing network functions.
   Core network functions for analytics like the network data analytics function (NWDAF) or core network functions for decision making like the AMF.
   RAN network functions e.g. a RAN network function in the gNB for automation like DSON functions, or for call processing like media access control functions.
An AI/ML MnS consumer may be a network operator or another management function of a 5GS that has interest in the MLEntities contained within or the AI/ML capabilities supported by an AI/ML-enabled function.
The AI/ML capabilities are the full set of characteristics and functionality (and typically (only) the inference-related functionality) that can be accomplished by the AI/ML-enabled function. These capabilities may include:
   data collection means, such as which sources are considered for decisions;
   data formatting means, including the considered structure, variables and ordering of the data;
   the model characteristics like number and relations among the layers and parameters of neural network models;
   the learning hyper-parameters like the loss functions and the distributions among training, validation and testing data.

In some cases, deployed MLEntities can be leveraged in producing a new MLEntity. This can be done using transfer learning which relies at least on task and domain similarity to deduce whether some parts of a deployed MLEntity can be reused in another domain / task with some modifications. For example, the knowledge contained in an MLEntity deployed to perform mobility optimization by day can be leveraged to produce a new MLEntity to perform mobility optimization by night. As such, the network or its management system needs to have the required management services for ML Transfer Learning (MLTL), which will be described in more detail later on, where ML Transfer Learning refers to means to allow and support the usage and fulfillment of transfer learning between any two MLEntities.

The concept of knowledge here represents any experiences or information gathered by the MLEntity through training, inference, updates or testing. This information or experiences can be in the form of—but not limited to—data statistics, data features, single/multiple NN layers, partial/entire MLModels (also referred to as ML model), or the output of an MLEntity.

The MLModel may be an independent managed entity in which case MLTL may include sharing parts of or the entire MLModel, which process may be termed as ML Model Transfer Learning. Alternatively, the MLModel may be an entity that is not independently managed but as an attribute of a managed MLEntity or ML-enabled function in which case MLTL may imply implementing the necessary means and services to enable the sharing of knowledge contained within the MLEntity or ML-enabled function, which will be described in more detail later on. In the following, this latter process will be referred to as MLTL to encompass both alternatives and the term MLEntity will be used to refer to either an ML model or any entity containing ML capabilities.

In the following, a description of example embodiments and an implementation example of the subject matter described herein will be given by referring to the drawings.

According to at least some example embodiments, an ML Transfer Learning function (also referred to as transfer learning process, ML transfer learning process, MLTL process or simply MLTL) and related services needed to realize the ML transfer learning process are provided. Knowledge (also referred to as knowledge available for sharing or available shared knowledge) shared in the transfer learning process can be any experiences or information gathered by the MLEntity through training, inference, updates or testing. This information or experiences can be in the form of—but not limited to—data statistics, data features, single/multiple NN layers, partial/entire MLModels, or the output of an MLEntity.

According to at least some example embodiments, also functionality and related services needed to manage and control the MLTL process and the related requests associated with transfer learning between two MLEntities or between the two MLEntities and a data repository (also referred to as knowledge repository, shared knowledge repository, or MLTL repository) are provided.

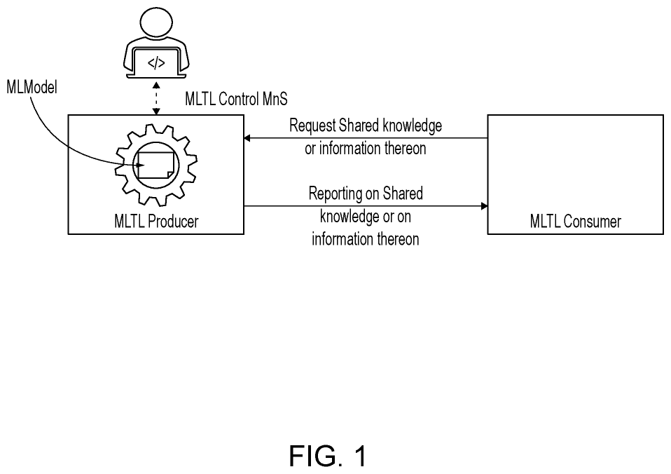

To support MLTL between an MnS consumer (e.g. an operator, or an MLEntity or ML-enabled function) and an MnS producer (e.g. an MLEntity or ML-enabled function), according to at least some example embodiments, as illustrated by FIG. 1, for the MnS consumer (also referred to as MLTL MnS consumer, MLTL consumer, or authorized consumer), functionality to discover the available shared knowledge from a given MnS producer (also referred to as MLTL MnS producer or MLTL producer) according to a set of criteria is provided.

Thereby, the authorized consumer may request an MLTL MnS producer to provide information on the available shared knowledge according to the set of criteria. As shown in FIG. 1, the MLTL consumer requests information on shared knowledge from the MLTL producer. Accordingly, the MLTL MnS producer receives this request (hereinafter referred to as MLKnowledgeInfoRequest or request for information on available knowledge) to report on information on available shared knowledge.

The MLKnowledgeInfoRequest comprises informational description (Metadata description) of at least task and domain related to knowledge required or a given network problem.

Further, to support MLTL between the MnS consumer and the MnS producer, according to at least some example embodiments, as illustrated by FIG. 1, for the MLTL MnS producer, functionality to report to the MnS consumer on information on the available shared knowledge according to a ReportingCriteria (also referred to as set of criteria) specified in the MLKnowledgeInfoRequest (also referred to as request for information on available knowledge) is provided. As shown in FIG. 1, the MLTL producer reports on the information on the shared knowledge to the MLTL consumer.

Further, to support MLTL between an MnS consumer and an MnS producer, according to at least some example embodiments, as illustrated by FIG. 1, for an authorized consumer functionality to request an MLTL MnS producer to provide some or all of the knowledge (e.g. at least part of the knowledge) available for sharing according to some stated criteria (also simply referred to as criteria) is provided. As shown in FIG. 1, the MLTL consumer requests shared knowledge from the MLTL producer. Accordingly, the MLTL MnS producer receives a request to provide shared knowledge, hereinafter referred to as MLKnowledgeRequest (also referred to as request for available knowledge).

Consequently, the MLTL MnS producer reports on the shared knowledge and instantiates an ML transfer learning process, hereinafter referred to as MLTLJob. The MLTLJob is responsible for adapting the required knowledge into a shareable format with the MLTL consumer.

According to at least some example embodiments, the MLTLJob is a continuous process where knowledge is shared with the MLTL consumer frequently to account for updates in the knowledge. In this case, the MLTL producer reports on the at least part of the knowledge by several transmissions of pieces or subsets of the at least part of the knowledge.

It is noted that the MLTL consumer may directly instantiate the MLTLJob without a separate request, as described in more detail below.

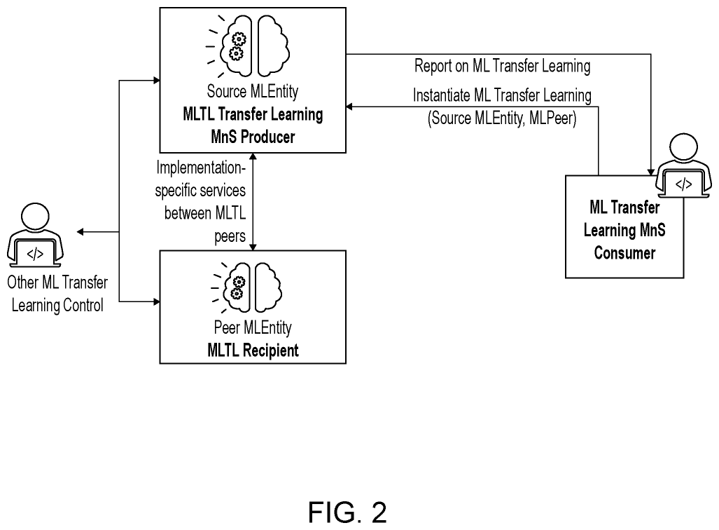

Further, to support MLTL between a recipient MLTL function and an MLTL producer as triggered by an MnS consumer, according to at least some example embodiments of the subject matter described herein, as illustrated by FIG. 2, for the authorized consumer, functionality to request the MLTL MnS producer to trigger and execute a transfer learning instance to a specified MLEntity or ML-enabled function (the recipient MLTL function, also referred to as MLTL recipient) is provided. This request is referred to in the following also as MLTLRequest or request for executing a transfer learning process. The request indicates the MLTL MnS producer as source MLEntity, and the MLTL recipient as MLPeer. Accordingly, the MLTL MnS producer receives an instantiation of MLTL as an MLTLJob specifying the recipient MLTL ML-enabled function or MLEntity (peer MLEntity). Between the source MLEntity and the Peer MLEntity, implementation-specific services are provided, e.g. knowledge is shared, which will be described in more detail later on.

Further, for the authorized consumer (e.g. an operator or the function/entity that generated the MLTLRequest), functionality to manage the request for available knowledge (MLKnowledgeRequest), e.g. to suspend, re-activate or cancel the MLKnowledgeRequest, or to adjust the description of the desired knowledge is provided.

Further, for an authorized consumer (e.g. an operator), functionality to manage or control a specific MLTLJob, e.g. to start, suspend or restart the MLTLJob, or to adjust the transfer learning conditions or characteristics, i.e. Modify MLTLJob attributes, is provided.

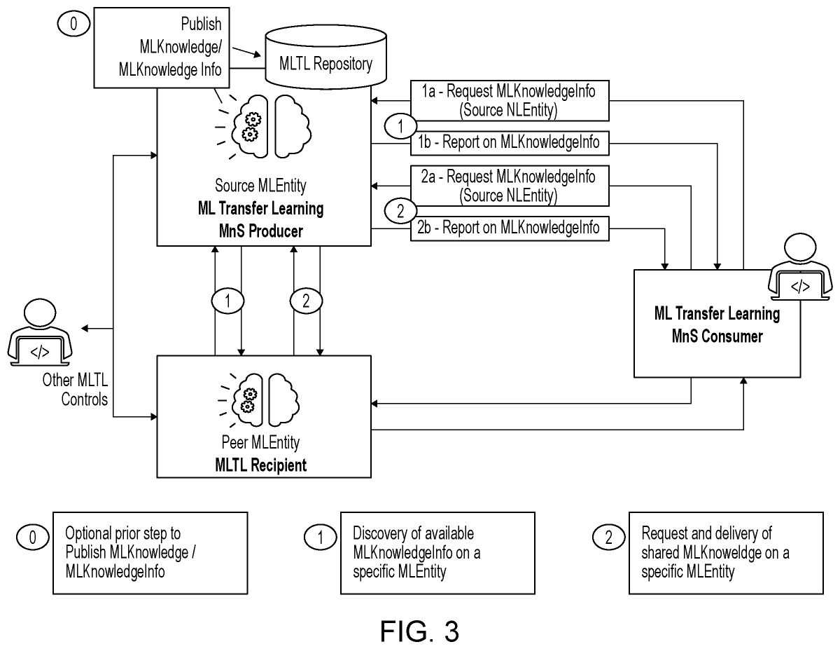

Further, as illustrated in FIG. 3, according to at least some example embodiments of the subject matter described herein, for an MLEntity (e.g. MLTL MnS Producer, Source MLEntity), functionality to register available knowledge (publish MLKnowledge/MLKnowledgeInfo) to a shared knowledge repository (MLTL Repository, KnowledgeRepo) e.g. through MLKnowledgeRegistration is provided, as illustrated by optional prior step 0. MLKnowledgeRegistration contains informational description (Metadata description) of at least the task and domain related to the registered knowledge or a network problem.

Further, functionality is provided for KnowledgeRepo, to act as the MLTL MnS Producer is to enable:
an authorized consumer to request a shared knowledge repository (herein called the KnowledgeRepo and acting as the MLTL MnS Producer) to provide information on the available knowledge according to a specified set of criteria;
an authorized consumer to request the KnowledgeRepo to provide some or all of the knowledge available for sharing according to specified criteria;
an authorized consumer (e.g. an operator or the function/entity that generated the MLKnowledgeRequest) to manage the request, e.g. to suspend, re-activate or cancel the MLKnowledgeRequest, or to adjust the description of the desired knowledge; and
an authorized consumer (e.g. an operator) to manage or control a specific MLTLJob, e.g. to start, suspend or restart the MLTLJob, or to adjust the transfer learning conditions or characteristics.

FIG. 3 further illustrates a step 1 of discovering available MLKnowledgeInfo on a specific MLEntity between the MnS consumer and the MnS Producer/MLTL Repository, and between the Source MLEntity and the Peer MLEntity. The procedure between the MnS consumer and the MnS Producer/MLTL Repository comprises a step la in which the MnS consumer requests MLKnowledgeInfo from the Source MLEntity, and the MnS producer reports on MLKnowledgeInfo in step 1b.

In addition, FIG. 3 illustrates a step 2 of requesting and delivering shared MLKnowledge on a specific MLEntity (MLTL Recipient, Peer MLEntity) between the MnS consumer and the MnS Producer/MLTL Repository, and between the Source MLEntity and the Peer MLEntity. The procedure between the MnS consumer and the MnS Producer/MLTL Repository comprises a step 2a in which the MnS consumer requests MLKnowledge from the Source MLEntity, and the MnS producer reports on MLKnowledge in step 2b.

Accordingly, at least some example embodiments of the subject matter described herein propose that:
The MLTL be modelled as a managed function that is contained in either any network-related Managed Function, Management Function or subnetwork. The MLTL then contains or is associated with the critical properties and modules needed to accomplish MLTL, including one or more of following:
   the list of available shared knowledge,
   the list of MLTLJobs, as well as
   the list of MLTLReport instances on any of MLKnowledgeInfoRequests, or MLKnowledgeRequests.
The MLTL has the capability and interfaces to instantiate and as such instantiates a MLTLJob based on MLKnowledgeRequests from authorized consumers. Correspondingly, The MLTL has the capabilities to adapt available knowledge in a shareable format with the MLTL MnS consumer.
The MLTL has the capabilities and control interfaces to allow and as such allows an operator or a management function to configure and manage one or more MLTLJobs.
The MLTL has the capability to compile MLTL reports that contain shared knowledge according to a specific MLKnowledgeRequest.
The shared knowledge is modelled as an information object that characterizes one or all of the following: data statistics, data features, single/multiple NN layers, partial/entire MLEntities, or the output of an MLEntity.

It is noted that the symbol of a person in FIGS. 1 to 3 represents an authorized consumer or a human operator managing the network.

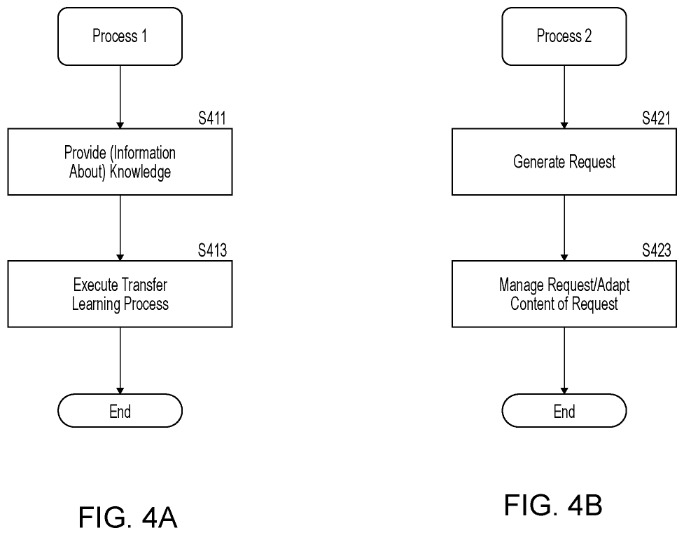

Now reference is made to FIG. 4A illustrating a process 1 executed by an MnS Producer or Knowledge Repository, and FIG. 4B illustrating a process 2 executed by an MnS Consumer, according to at least some example embodiments. According to at least some example embodiments, the MnS Producer or Knowledge Repository is hardware that includes software, or simply software that is executable by at least one processor of one or more computers, e.g., a distributed computing system or a cloud computing system.

Similarly, according to at least some example embodiments, the MnS consumer is hardware that includes software, or simply software that is executable by at least one processor of one or more computers, e.g., a distributed computing system or a cloud computing system.

Referring to process 1, at step S411 of process 1, information about knowledge available for sharing is provided, or knowledge available for sharing is provided. For example, step S411 comprises reporting on the information about the knowledge available for sharing, based on a request for information on available knowledge. This is similar to the reporting on information on shown in FIG. 1, or step 1b of FIG. 3. Then, process 1 advances to step S413.

At step S413, a transfer learning process for sharing at least part of the knowledge available for sharing is executed. Then, process 1 ends.

For example, at step S413, the transfer learning process is executed between the MLTL consumer and the MLTL producer as shown in FIG. 1, between the Source MLEntity and the Peer MLEntity as shown in FIG. 2, or between the Source MLEntity and the Peer MLEntity as shown in FIG. 3.

Further, for example, step S413 comprises executing the transfer learning process by reporting on at least part of the knowledge available for sharing, based on a request for available knowledge, similarly as shown in FIG. 1 by the reporting on shared knowledge or step 2b of FIG. 3.

Alternatively or in addition, step S413 comprises executing the transfer learning process by reporting on at least part of the knowledge available for sharing, based on a request for executing the transfer learning process, similarly as shown in FIG. 2 by the report on ML Transfer Learning.

Referring to process 2, at step S421 of process 2, a request for information on available knowledge from a management service producer or data repository is generated. This is similar to the request of information on shared knowledge in FIG. 1, and step la of FIG. 3.

Alternatively or in addition, at step S421, a request for available knowledge from a management service producer or data repository is generated. This is similar to the request of shared knowledge in FIG. 1, and step 2a of FIG. 3.

Alternatively or in addition, at step S421, a request for executing a transfer learning process between a management service producer or data repository and an ML entity or ML-enabled function is generated. This is similar to instantiating ML Transfer Learning shown in FIG. 2. Then, process 2 advances to step S423.

At step S423, the request for available knowledge or the request for executing the transfer learning process is managed, or content of the request for available knowledge or the request for executing the transfer learning process is adapted. Then, process 2 ends.

For example, as described above, at step S423, the MnS consumer manages the request for available knowledge, e.g. suspends, re-activates or cancels the MLKnowledgeRequest, or adapts content of the request for available knowledge, e.g. adjusts the description of the desired knowledge. Further, as described above, at step S423, the MnS consumer manages or controls the request for executing the transfer learning process (a specific MLTLJob), e.g. starts, suspends or restarts the MLTLJob, or adapts the request for executing the transfer learning process, e.g. adjusts the transfer learning conditions or characteristics.

In the following, example embodiments and an implementation example of MLTL will be described in more detail.

First, meaning of Knowledge will be described.

### <Types of Knowledge>

There are different types of knowledge that can be shared. Correspondingly, the character of the knowledge to be shared should be structured according to these types. In general the following information (or types of knowledge) should be supported:

Rules: A rule is of the form <<if condition on some variable then action on some variable>> e.g. the rule may be that <<if variable_x=value_v1, then variable_y=value_v2>>. Correspondingly knowledge contained in a rule may be shared as a pair of tuples [predictor and response], where the Predictor contains the condition and the Response contains the actions corresponding to that Predictor.

Rule: [predictor; response]

Statistics: A statistic is a measure of a fact about some data. Statistics may among others include any of medians, mean, standard deviation, range, quartiles, deciles. In general, it is represented by a name to indicate the type of statistic and a response which is an array of values whose size is fixed depending on the specific statistic. For example, the Response is of size 1 for the mean and standard deviation but size 10 for the deciles.

Statististic: [statististicName; response]

Statistical Distributions: A Statistical distribution is a representation of facts about or nature of some data. Distributions may among others include any of PDF, CDF, . . . In general, it is represented by a name to indicate the specific type of distribution, a predictor which is an array of bins for which the distribution has values and a response which is an array of values corresponding to the predictor. The lengths of the Predictor and the Response are equal but not fixed in size.

Distribution: [distributionName; predictor; response]

Statistical Correlations: Statistical correlation is a representation of causal or not-causal statistical relationships between two random variables. Multiple correlation techniques may be computed, each characterized by a specific name and a set of correlation parameters that characterize the computed correlation. Each correlation parameter has a specific definition and meaning and as such can be represented by a simple tuple of parameterName and value. Otherwise, any Statistical Correlation will have a response, which is an array of values specific to the computed correlation. For example, the correlation may result into and thus has a response that is a matrix (multi-dimensional array) of the pairwise linear correlation coefficients (rho). However, the statistical correlation may also have an optional predictor. For example, correlation may besides the correlation coefficients, result into a matrix of the p-values, where each element of the p-value matrix is the p-value for the corresponding element of rho.

Correlation: [correlationName; correlationParameters; optionalPredictor; response]

Regressions: A regression defines a relationship between a response (output) variable, and one or more predictor (input) variables. However, the regression is characterized by a specific model with a specific regressionModelName and may have a set of regressionModelParameters used for computing the regression. For example, logistic regression is defined by the logistic function of the form in equation 1, where μ is a location parameter (the midpoint of the curve, where =½}) and s is a scale parameter that defines the degree to which the distribution spreads out.

In that case, the regressionModelName is logistics regression but the location and scale parameters (μ and S) may need to be staded as regressionModelParameters for the regression to be fully described. Note that the Predictor and Response may be multi-dimensional.

Regression: [regressionModelName; regressionModelParameters; predictor; response]

Classifications: a classification describes a categorization relationship between a response (output) variable, and one or more predictor (input) variables. However, similar to regression, the classification is characterized by a specific model with a specific regressionModelName and may have a set of classificationModelParameters used for computing the classification.

Classification: [correlationName; Correlation parameters; predictor; response]

Neural network model (-portions): the knowledge may be a neural network model or a portion thereof (e.g. 1 or more Layers of the model). The portion to be shared should be identified by a name that clarifies which portion of the model is to be shared, e.g., the neural network model name or the name or identifier of the layer. The knowledge is then characterized by a Predictor which is an array of the parameters of the neural network, e.g. identified by their positions in the neural network model, and a Response which holds the parameter values corresponding to the Predictor.

Neural network: [nNModelPortionName; predictor; response]

Clustering: this kind of unsupervised algorithm can provide information on the number and kind of clusters, percentage of population in each of the clusters, the effectiveness of the clusters. Effectiveness of the clusters can be derived using different metrics. These include but are not limited to
1. Silhouette score: −1 indicates incorrect clustering, +1 indicates dense clustering, 0 indicates overlap clustering
2. Calinski-Harabasz Index: the Higher the score, the better separated dense clustering is available.
3. Davies-Bouldin Index: 0 is the lowest possible value and indicates better partitioning.

### <Structure of Knowledge>

Given the observations above, the knowledge may be taken as the statement that: “for the variable somevariable, the KnowledgeName parameterized by KnowlegeParameters for input Predictor is/corresponds to Output Response”. In other words, MLKnowledge on a given variable may in general be described to have one or more of following four attributes also illustrated by Table 1 below:
the KnowledgeName
KnowledgeParameters
Predictor of length (inputLength=array(length_n, array))
Output Response

### Where:

Predictor: is a specific input value with length equal to the length of a data sample or length of the statistic domain (e.g. the length of CDF/PDF bins),
Response: is a specific output value whose length depends on the specific knowledge that is being shared.

It is to be noted that other pieces of knowledge may also be possible as derivatives of the above knowledge types. For example, knowledge on dimensionality reduction is equivalent to either regression or classification, but where each entry of the Response has reduced dimensions compared to that of the Predictor.

TABLE 1
Examples of knowledge

| Knowledge | Knowledge | Knowledge | | |
|---|---|---|---|---|
| type | Name | Parameters | Predictor | Response |
| Statistic | mean | — | — | float value |
| Distribution | CDF | — | Array of CDF | Array of floats |
| | | | bins | |
| Correlation | Correlation | Correlation | Optional | Correlation_value |
| | model (e.g. | parameters | variable | |
| | pearson) | | | |
| Regression | Regression | Regression | Input variable | output variable |
| | model name (e.g. | model | value(s) | value(s) |
| | linear regression) | parameters | | |
| NN | Layer, model | — | Model | Parameter Values |
| | portion or Model | | parameters | (type float) |
| Clustering | Type of | use | | |
| | Clustering | case(String), | | |
| | | context(String) | | |
| | | and Clustering | | |
| | | effectiveness | | |
| | | index(float), | | |
| | | percentage | | |
| | | population in | | |
| | | each | | |
| | | cluster(float) | | |

It is noted that if knowledge types have different structure, then each type should be standardized. Or if all knowledge types use the same structure, then only the common structure is standardized.

Next, discovering shared knowledge will be described.

As described above, available knowledge can be discovered by any authorized consumer, in particular either an operator or some other network or management function that is interested in that knowledge. The knowledge may be discovered through either the knowledge source function (e.g. MnS producer or source MLEntity shown in FIGS. 1 to 3) or a shared repository (e.g. MLTL repository shown in FIG. 3) where that knowledge is registered.

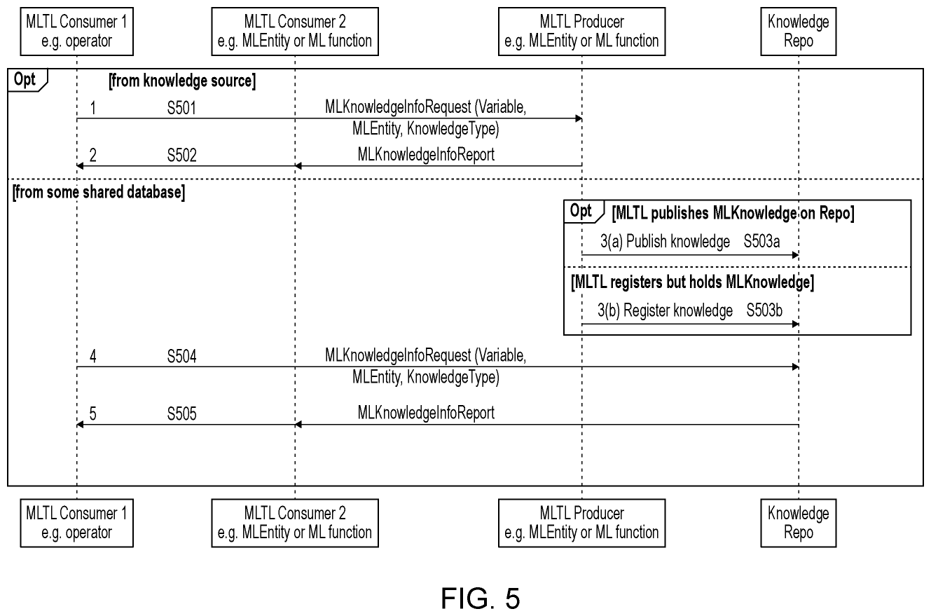

Referring to FIG. 5, a procedure of discovering shared knowledge is illustrated. At S501, an MLTL consumer (MLTL consumer 1, e.g. operator) may request information on available shared knowledge offered by an MLTL MnS producer (e.g. MLEntity or ML function/ML-enabled function). The request (MLKnowledgeInfoRequest) for information on available knowledge may state the variable for which knowledge is desired, as described above with respect to the types of knowledge, and one or more of the types of knowledge (KnowledgeType). It may also include the MLEntity whose knowledge is needed, e.g. in cases where the ML function has more than one MLEntity.

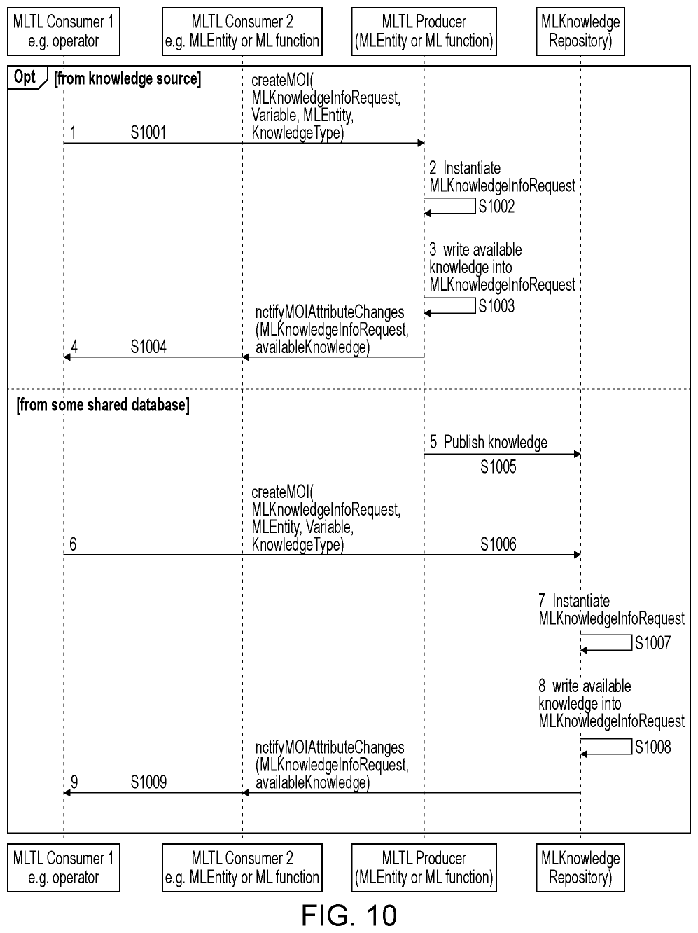

At S502, the MLTL MnS producer may then report and provide information on available shared knowledge based on the request received in S501 from the MLTL Consumer (MLTL consumer 1, e.g. operator). The MLTL MnS producer may report to the MLTL consumer 1 or to an MLTL consumer 2, e.g. an MLEntity or ML function/ML-enabled function indicated in the request received in S501, using MLKnowledgeInfoReport. This may be implemented using a notifyMOIAttribteChanges notification emitted by a MLKnowledgeInfoRequest object instantiated on the MLTL MnS producer, the notification emitted when the MLTL MnS producer writes the available values into the MLKnowledgeInfoRequest instance, as will be described later on referring to FIG. 10.

Alternatively, the MLTL MnS producer may either publish (S503a) its available knowledge to a shared repository (KnowledgeRepo) from where the knowledge can be discovered and requested by any authorized consumer, or publish (S503b) information on its available knowledge to the shared repository, i.e. register its available knowledge but still holds the available knowledge.

Subsequent to the publication, at S504, any MLTL consumer (e.g. another MLEntity) may request from the repository information on available shared knowledge generated or provided by a specific MLTL MnS producer. Since multiple sources may publish their knowledge on the repository, the request (MLKnowledgeInfoRequest) has to state the MLTL Mns producer whose knowledge is required, besides stating the variable, the MLEntity and the knowledge types.

Similarly, at S505, the knowledge repository, acting as the MLTL MnS producer, may report and provide information on available shared knowledge based on the received request in S504 from the MLTL Consumer (e.g. another MLEntity), using MLKnowledgeInfoReport. This may be implemented using a notifyMOIAttribteChanges notification emitted by a MLKnowledgeInfoRequest object instantiated on the knowledge repository, the notification emitted when the knowledge repository writes the available values into the MLKnowledgeInfoRequest instance, as will be described later on referring to FIG. 10.

Information in MLKnowledgeInfoReport may include data statistics, Neural Network layer, portion or full Neural Network, and may indicate for each report instance one of more of following: the variable, KnowledgeName and possible KnowledgeParameter combinations for that Variable-KnowledgeName combination.

Next, requesting and receiving knowledge will be described.

Given information about available shared knowledge, an authorized consumer, in particular either an operator or some other network or management function shall be able to request and receive the specific knowledge that they are interested in. The knowledge may be requested and received from either the knowledge source function or from a shared repository where that knowledge has been registered.

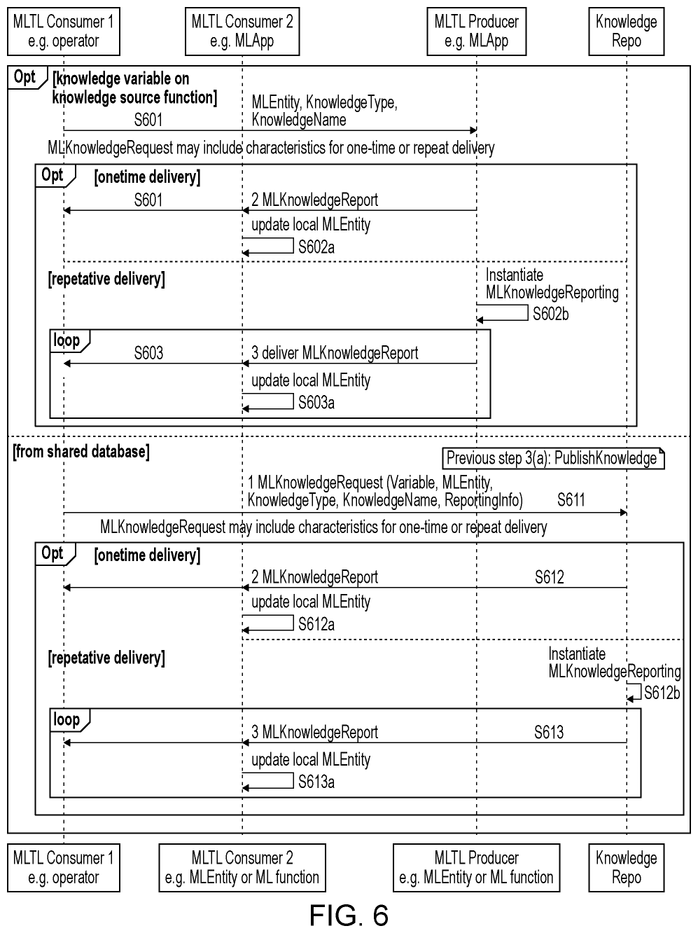

Referring to FIG. 6 illustrating a procedure of requesting and receiving knowledge, at S601, an MLTL consumer (e.g. an MLEntity or AI/ML-enabled function) may request a specified piece of shared knowledge that is a subset of the available shared knowledge. The request (e.g. MLKnowledgeRequest) for delivery of a piece of knowledge should state the variable for which knowledge is desired and the name of the specific knowledge (e.g. KnowledgeName) that is desired. However, the request may also state the type of knowledge (e.g. KnowledgeType) and may also include the MLEntity whose knowledge is needed, e.g. in cases where the MLTL producer has more than one MLEntity. The request may also include special characteristics related to the transmission of the knowledge and to the MLTLJob to be performed. For example, it may state the frequency of knowledge sharing (e.g. characteristics for repetitive delivery) e.g. in ReportingInfo if the knowledge transmission is to be performed more than once or may indicate the recipient of the knowledge if the recipient (e.g. MLTL consumer 2, e.g. ML App) is different from the MLTL consumer that has submitted the request.

The MLTL MnS producer provides one or more pieces/subset of knowledge for a given request in S601, using e.g. MLKnowledgeReport. Typically, the default behavior is a one-time execution of MLTL knowledge transmission at S602. Otherwise, the request should specify that multiple responses with a specified frequency should be executed. In that case, the MLTL may instantiate a reporting instance at S602b that will then emit the reports at the specified frequency.

The MLTL then establishes a loop through which it delivers the reports of the requested knowledge pieces to the MLTL consumer or to the recipient ML function at S603, according to the frequency specified in the request in S601.

At S602a and S603a, the MLTL consumer 2 updates its local MLEntity based on the MLKnowledgeReport received in S602 or S603.

It is to be noted that the same steps 601-603 can be executed via the KnowledgeRepo if the knowledge has been published at the KnowledgeRepo in step S503a of FIG. 5, in which case the requests are sent to and the responses are provided by the KnowledgeRepo. That is, steps S611, S612, S612a, S612b, S613 and S613a are similar to the above-described steps S601, S602, S602a, S602b, S603 and S603a.

Otherwise, if only the available knowledge is registered on the KnowledgeRepo but not published, the steps 1 to 3 apply as described above with the request sent to and the responses provided by the MLTL producer.

Next, triggering TL on MLTL producer or on MLTL recipient function will be described.

Besides requesting and delivering knowledge, MLTL may be accomplished by triggering the MLTL process (machine learning process) between two AI/ML enabled functions or MLEntities. Thereby, two options should be supported—initiating the process on the MLTL source function (e.g. the MLTL MnS producer/source MLEntity shown in FIGS. 2 and 3) first which then connects with its Recipient MLTL function (MLTL Recipient/Peer MLEntity shown in FIGS. 2 and 3) to undertake the process, or initiating the process on the MLTL recipient first which then connects with its MLTL source function.

In both cases, it is assumed that there has been prior interaction between the consumer and the MLTL producer to identify that the MLTL has the MLKnowledge needed for the respective MLTL process.

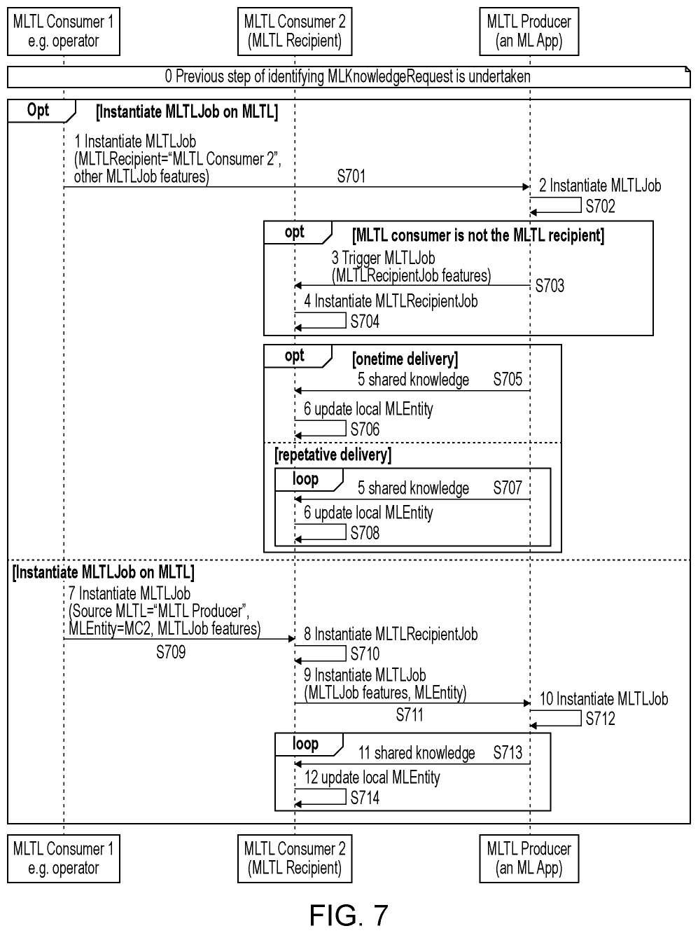

FIG. 7 illustrates a procedure of triggering TL on MLTL producer and a procedure of triggering TL on MLTL recipient function.

Then for the case where MLTL is triggered on the MLTL source function (also referred to as MLTL source MnS producer or MLTL producer, e.g. an ML App), at S701, an authorized consumer (MLTL consumer 1, e.g. operator) may instantiate the MLTLJob on the MLTL source MnS producer (MLEntity), e.g. using Instantiate MLTLJob. The requesting consumer may not be the same as the intended MLTLRecipient function, which is e.g. the case where the operator triggers the MLTL towards another network or management function. For that reason, the instantiation request specifies the MLTLRecipient with which the MLTLsource should perform knowledge sharing in case the MLTLRecipient is different from the MLTL MnS Consumer, but may also state other features (e.g. other MLTLJob features) that may be critical to the MLTLJob including the subset of shared knowledge to be shared between MnS producer and intended MLTLRecipient.

At S702, the MLTL MnS producer instantiates the MLTLJob and may return a notification to the consumer indicating the instantiation of the job, the notification including the identification of the MLTLJob.

If the requesting consumer is not the same as the intended MLTLRecipient function, the MLTL MnS producer, at S703, may trigger a recipient job on the intended MLTLrecipient function, e.g. to be named the MLTLrecipientJob, which shall handle the MLTL process on the recipient side MLTL function. The MLTLrecipientJob is especially needed for the cases where MLTL process shall involve multiple exchanges between the source MLTL function and the recipient MLTL function.

The MLTL recipient function may accordingly instantiate the MLTLrecipientJob which shall handle the subsequent MLTL process, at S704.

Then, the MLTL MnS producer may trigger a loop to report and provide the specified subset of knowledge according to the instantiation request in 701 to the MLTLRecipient. Unless otherwise specified in the request, the default behavior is a one-time execution of MLTL at step S705. If specified, the MLTL execution is performed in step S707 according to the frequency specified in the MLTLJob in step S701.

Finally, at S706 or S708, the MLTLRecipient function applies the received MLKnowledge (shared knowledge) to update its MLEntities.

For the case where MLTL is triggered on the MLTLRecipient function, at S709, the authorized consumer (e.g. operator) may instantiate the MLTLJob on the MLTLRecipient (MLEntity), the instantiation request specifying the MLTL MnS Producer besides the other features of the MLTLJob. Alternatively, the operator may notify the MLTLRecipient of the availability of a MLTL MnS Producer. Either way, the MLTLRecipient may instantiate a MLTL recipient Job at S710 which shall handle the subsequent MLTL process.

At S711, the MLTLRecipient may instantiate the MLTLJob on the MLTL MnS producer. The instantiation request specifies the other features that may be critical to the MLTLJob including the subset of shared knowledge to be shared between MLTL MnS producer and MLTLRecipient. In a simpler implementation, the instantiation request may be replaced with a MLTLRecipient's request for shared knowledge (e.g. request for available knowledge, MLKnowledgeRequest) from the MLTL MnS producer.

The MLTL MnS producer may accordingly instantiate the MLTLJob at S712, which shall handle the subsequent MLTL process. Otherwise, if the MLTLRecipient simply requests for shared knowledge, the MLTL MnS producer may simply instantiate a MLTLJob.

Then, at S713, the MLTL MnS producer may trigger a loop to report and provide the specified subset of knowledge according to the instantiation or request in S711 to the MLTLRecipient. Unless otherwise specified in the request, the default behavior is a one-time execution of MLTL. If specified, the MLTL execution is performed according to the frequency specified in the MLTLJob specification in S711.

Finally the MLTLRecipient function applies the received MLKnowledge to update its MLEntities at S714.

Next, an implementation example will be described.

As described above, existing ML capability can be leveraged in producing or improving new or other ML capability. Specifically, using transfer learning knowledge contained in one or more MLEntities may be transferred to another MLEntity. Transfer learning relies on task and domain similarity to deduce whether some parts of a deployed MLEntity can be reused in another domain/task with some modifications. As such, aspects of transfer learning that are appropriate in multi-vendor environments need to be supported in network management systems. For example, the knowledge contained in an MLEntity deployed to perform mobility optimization by day can be leveraged to produce a new MLEntity to perform mobility optimization by night. As such, the network or its management system needs to have the required management services for ML Transfer Learning (MLTL), where ML Transfer Learning refers to means to allow and support the usage and fulfillment of transfer learning between any two MLEntities.

For the transfer learning, as described above, the MnS producer shares its knowledge with the recipient ML function, either simply as a single knowledge transfer instance or through an interactive transfer learning process. The concept of knowledge here represents, as described above, any experiences or information gathered by the MLEntity through training, inference, updates or testing. This information or experiences can be in the form of—but not limited to—data statistics or other features of the underlying ML model. It may also be as single/multiple NN layers of the ML model or block parts or entire MLModels. It may also be the output of an MLEntity. According to the implementation example, 3GPP management systems are enhanced by providing means for an MnS consumer to discover this potentially sharable knowledge as well as means for the provider of MLTL to share the knowledge with the MnS consumer of any stated recipient ML Entity or function, as described above.

As described above, the transfer learning may be triggered by a consumer (e.g. MLTL (MnS) consumer shown in FIGS. 1-3 and 5 to 7) either to fulfil the learning itself or for it to be accomplished with another recipient. The Entity containing the knowledge may be an independent managed entity (the MLEntity) in which case process may include sharing parts of or the entire MLModel. Alternatively, the MLModel may also be an entity that is not independently managed but is an attribute of a managed MLEntity or ML function in which case MLTL does not involve sharing the ML model or parts thereof but may imply implementing the means and services to enable the sharing of knowledge contained within the MLEntity or ML-enabled function. The 3GPP management system is enhanced by providing means and the related services needed to realize the ML transfer learning process.

Specifically, the 3GPP management system is enhanced by providing means for an MnS consumer to request and receive sharable knowledge as well as means for the provider of MLTL to share the knowledge with the MnS consumer or any stated recipient ML Entity or function, as described above. Similarly, the 3GPP management system is enhanced by providing means for an MnS consumer to manage and control the MLTL process and the related requests associated with transfer learning between two MLEntities or between the two MLEntities and a Shared knowledge repository, as described above.

According to the implementation example, the 3GPP management system has a capability enabling an authorized MnS consumer to discover the available shared knowledge from a given MLTL MnS producer according to a stated set of criteria.

According to the implementation example, the 3GPP management system has a capability enabling an authorized MnS consumer to request a MLTL MnS producer to provide some or all of the knowledge available for sharing according to some stated criteria.

According to the implementation example, the 3GPP management system has a capability enabling an authorized MnS consumer to request a MLTL MnS producer to trigger and execute a transfer learning instance to a specified MLEntity or ML-enabled function. Accordingly, the MLTL MnS producer receives an instantiation of MLTL as an MLTLJob specifying the recipient MLTL ML-enabled function or MLEntity.

According to the implementation example, the 3GPP management system has a capability for a MLTL MnS producer to report to an authorized consumer on the available shared knowledge according to a ReportingCriteria specified in a request for information on available Knowledge.

According to the implementation example, the 3GPP management system has a capability for an authorized consumer (e.g. an operator or the function/entity that generated the request for available Knowledge or for information thereon) to manage the request for knowledge or its information and subsequent process, e.g. to suspend, re-activate or cancel the MLKnowledgeRequest; or to adjust the description of the desired knowledge.

According to the implementation example, the 3GPP management system has a capability for an authorized consumer (e.g. an operator or the function/entity that generated the request for MLTL) to manage or control a specific MLTLJob, e.g. to start, suspend or restart the MLTLJob; or to adjust the transfer learning conditions or characteristics i.e. Modify MLTLJob attributes.

According to the implementation example, the 3GPP management system has a capability enabling an MLEntity to register available knowledge to a shared knowledge repository, e.g. through a MLKnowledgeRegistration process.

According to the implementation example, the 3GPP management system has a capability enabling KnowledgeRepo to act as the MLTL MnS Producer to enable an authorized consumer to request the shared knowledge repository to provide information on the available knowledge according to some given criteria.

According to the implementation example, the 3GPP management system has a capability enabling KnowledgeRepo to act as the MLTL MnS Producer to enable an authorized MnS consumer to request the KnowledgeRepo to provide some or all of the knowledge available for sharing according to some given criteria.

According to the implementation example, the 3GPP management system shall have a capability enabling KnowledgeRepo to act as the MLTL MnS Producer to enable an authorized MnS consumer (e.g. an operator or the function/entity that generated the MLKnowledgeRequest) to manage the request, e.g. to suspend, re-activate or cancel the MLKnowledgeRequest; or to adjust the description of the desired knowledge.

According to the implementation example, the 3GPP management system has a capability enabling KnowledgeRepo to act as the MLTL MnS Producer to enable an authorized MnS consumer (e.g. an operator) to manage or control a specific MLTLJob, e.g. to start, suspend or restart the MLTLJob; or to adjust the transfer learning conditions or characteristics.

According to the implementation example, to discover sharable knowledge, as described above with respect to FIGS. 1 to 7:
The MnS consumer may send a request to the MLTL MnS producer to provide information on the available shared knowledge. In other words, the MLTL MnS producer receives a request to report on the available shared knowledge.
The request may be generic or may state a set of criteria which the knowledge should fulfil.
The request may be referred to as MLKnowledgeInfoRequest.
The MLKnowledgeInfoRequest has informational description (Metadata description) of the task and domain related to the required knowledge or a given network problem.
An MLEntity or a function containing an ML Entity may register its available knowledge to a shared knowledge repository, e.g. through a MLKnowledgeRegistration process.
The MLKnowledgeRegistration contains informational description (Metadata description) of the task and domain related to the registered knowledge or suitable network problem.

According to the implementation example, to share knowledge, as described above with respect to FIGS. 1 to 7:
An IOC for an ML Knowledge request is introduced. The MnS consumer may send a request to the MLTL MnS producer to share a specific kind/type of knowledge, i.e. the MLTL MnS producer receives a request to provide shared knowledge. The request may be referred to as MLKnowledgeRequest.
An IOC for an ML transfer learning process or job which is instantiated for any request for transfer learning or ML knowledge transfer is introduced. The MLTL MnS producer instantiates a ML transfer learning process. The process may be referred to as MLTLJob.
The MLTLJob is responsible for adapting the required knowledge into a shareable format with the MLTL consumer.
MLTLJob may be a continuous process where knowledge is shared with the MLTL consumer frequently to account for updates in the knowledge.

As described above with respect to FIGS. 1 to 7, the MnS consumer is able to directly instantiate the MLTLJob without a separate request.

The above-mentioned information objects enable ML functions to exchange their knowledge to be used towards transfer learning but in a way that vendor specific aspects of the ML models are not exposed.

Next, information model definitions for ML transfer learning according to the implementation excample will be described. In particular, information object classes (IOCs) and dataTypes needed to realize ML Transfer learning in 3GPP communication networks as well as the relationships among these IOCs and dataTypes will be described.

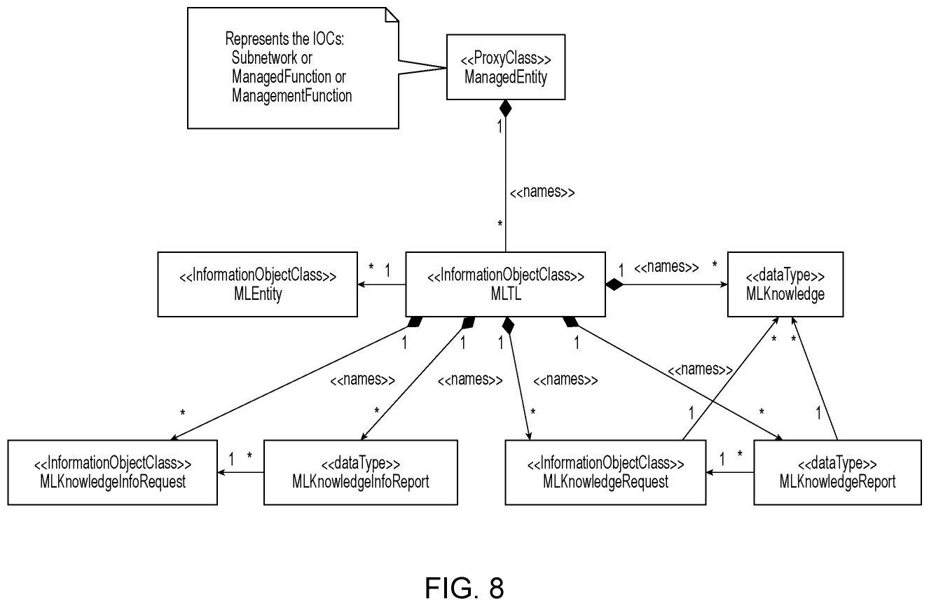

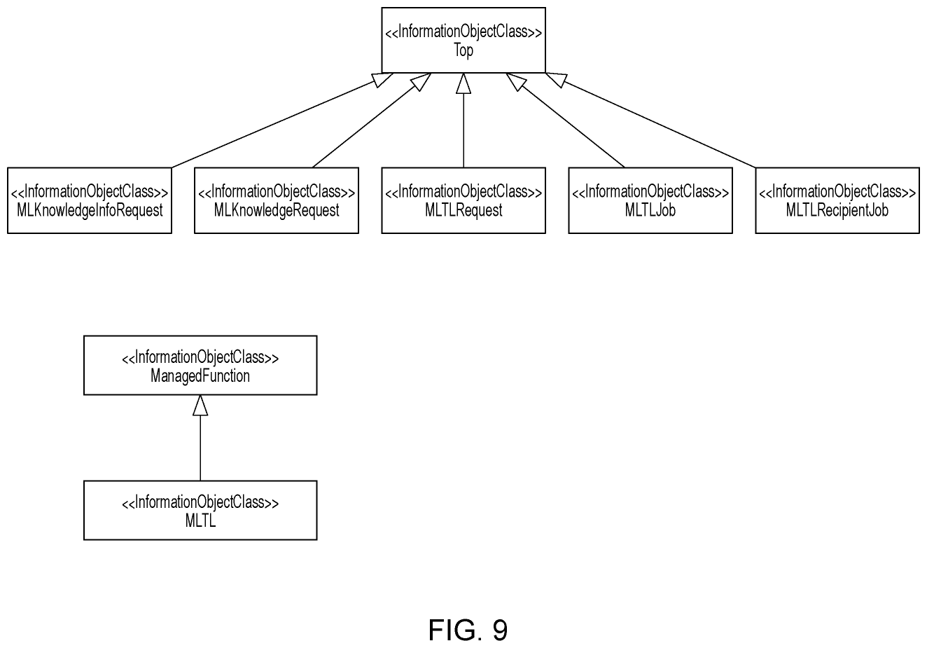

The MLTL may be modelled as illustrated by FIGS. 8 and 9. FIG. 8 illustrates the information model for ML knowledge sharing and transfer learning, and FIG. 9 illustrates MLTL inheritance relations for ML knowledge sharing and transfer learning.

The IOC MLTL represents the properties of MLTL. Each MLTL is a managed object instantiable from the MLTL information object class and name-contained in either a Subnetwork, a ManagedFunction or a ManagementFunction. The MLTL is a type of managed Function, i.e. the MLTL is a subclass of and inherits the capabilities of a managed Function.
Each MLTL is be associated with one or more MLEntities.
Each MLTL is associated with one or more MLTLJobs instantiated on it.
Each MLTL may be associated with one or more MLKnowledgeInfoRequests and their respective MLKnowledgeInfoReports.
Each MLTL may be associated with one or more MLKnowledgeRequests and their respective MLKnowledgeReports.

The MLTL IOC includes the attributes shown in below Table 2:

| | Support | | | | |
|---|---|---|---|---|---|
| Attribute name | Qualifier | isReadable | isWritable | isInvariant | isNotifyable |
| MLEntities | CM | T | F | F | F |
| MLTLJobs | M | T | F | F | F |
| MLKnowledgeInfoRequests | O | T | T | F | T |
| MLKnowledgeInfoReports | O | T | F | F | F |
| MLKnowledgeRequests | O | T | T | F | T |
| MLKnowledgeReports | O | T | F | F | F |

Further, IOC MLKnowledgeInfoRequest represents the properties of MLKnowledgeInfoRequest.

For each request to discover available MLKnowledge, a consumer may create a new MLKnowledgeInfoRequest on the MLTL, i.e., MLKnowledgeInfoRequest is an information object class that is instantiated for each request for knowledge information (also referred to as request for information on available knowledge).
Each MLKnowledgeInfoRequest is associated to either one MLEntity or one knowledge variable or both.
If only a MLEntity is specified, then information on all knowledge variables related to this entity are requested.
If only a variable is specified, then information on this variable is requested from all available MLentities.
If both are specified, then information on a specific variable is requested from a specific MLEntity.
KnowledgeType may be specified in the request. If not specified, information regarding all KnowledgeTypes are by default requested.

The MLKnowledgeInfoRequest IOC includes the attributes shown in below Table 3:

| | Support | | | | |
|---|---|---|---|---|---|
| Attribute name | Qualifier | isReadable | isWritable | isInvariant | isNotifyable |
| MLKnowledgeInfoRequestId | M | T | F | F | F |
| MLEntity | CM | T | F | F | F |
| Variable | CM | T | F | F | F |
| KnowledgeType | O | T | F | F | F |

It is noted that the MLKnowledgeInfoRequest IOC may further include information on context that shall help the MLTL producer/the Knowledge Repository to unambiguously identify the knowledge and indicate the same. That is, practically, different kinds of knowledge are possible for the same variable in the same MLTL producer/Knowledge Repository based on different input contexts. For instance, a NN for load prediction could exist for an urban area as well as rural area in the same MLEntity, but in both cases, the “variable” would be the same. Contexts capture such differentiating information and include, for example, geographical area, time, etc.

Further, IOC MLKnowledgeRequest represents the properties of MLKnowledgeRequest.

For each request to discover available MLKnowledge, a consumer may create a new MLKnowledgeRequest on the MLTL, i.e., MLKnowledgeRequest is an information object class that is instantiated for each request for knowledge information (also referred to as request for available knowledge).
Each MLKnowledgeRequest is associated to either one MLEntity or one knowledge variable or both.
If only a MLEntity is specified, then all knowledge variables related to this entity are requested.
If only a variable is specified, then this variable is requested from all available MLEntities.
If both are specified, then a specific variable is requested from a specific MLEntity.
KnowledgeType may be specified in the request. If not specified, all KnowledgeTypes are by default requested.
Each MLKnowledgeRequest may specify one or more KnowledgeNames related to the Variable and KnowledgeType specified above.
For some KnowledgeNames, the MLKnowledgeRequest may specify certain KnowlegeParametersSets in the request if needed. Each KnowlegeParametersSet is a list of parameter-value combinations.
Each MLKnowledgeRequest may specify details of the reporting frequency of the MLKnowledge in ReportingInfo. If not specified, the default is one-time execution.

The MLKnowledgeRequest IOC includes the attributes shown in below Table 4:

| | Support | | | | |
|---|---|---|---|---|---|
| Attribute name | Qualifier | isReadable | isWritable | isInvariant | isNotifyable |
| MLKnowledgeRequestId | M | T | F | F | F |
| MLEntity | M | T | F | F | F |
| Variable | M | T | F | F | F |
| KnowledgeType | O | T | F | F | F |
| KnowledgeName | O | T | F | F | F |
| KnowlegeParametersSets | CM | T | T | F | T |
| ReportingInfo | O | | | | |

Further, IOC MLTLRequest represents the properties of MLTLRequest.

For each request to undertake transfer learning, the MLTL MnS consumer may create a new MLTLRequest on the MLTL, i.e., MLTLRequest is an information object class that is instantiated for each request for transfer learning (also referred to as request for executing a transfer learning process).
Each MLTLRequest is associated to at least one MLEntity.
The MLTLRequest may specify the MLTLRecipient which may be an MLEntity or ML function.
Each MLTLRequest may specify details of the reporting that may be provided to the MnS consumer regarding the MLTL process.

The MLTLRequest IOC includes the attributes shown in below Table 5:

| | Support | | | | |
|---|---|---|---|---|---|
| Attribute name | Qualifier | isReadable | isWritable | isInvariant | isNotifyable |
| MLTLRequestId | M | T | F | F | F |
| MLEntity | M | T | F | F | F |
| MLTLRecipient | O | T | F | F | F |

Further, IOC MLTLJob represents the properties of MLTLJob.

For each request to undertake transfer learning, the producer of MLTL may instantiate an MLTLJob following reception of an MLTLRequest or after the MnS consumer has instantiated the MLTLRequest on the MnS producer. The MLTLJob may also be directly instantiated by the MnS consumer without the intermediate step of instantiating an MLTL Request. As such, the MLTLJob is an information object class that is instantiated for each transfer learning process.
Each MLTLJob is associated to at least one MLEntity.
The MLTLJob may specify the MLTLRecipient which may be an MLEntity or ML function.
Each MLTLJob may specify details of the reporting that may be provided to the MnS consumer regarding the MLTL process.

The MLTLJob IOC includes the attributes shown in below Table 6:

| | Support | | | | |
|---|---|---|---|---|---|
| Attribute name | Qualifier | isReadable | isWritable | isInvariant | isNotifyable |
| MLTLRequestId | M | T | F | F | F |
| MLEntity | M | T | F | F | F |
| MLTLRecipient | O | T | F | F | F |

Further, IOC MLTLRecipientJob represents the properties of MLTLRecipientJob.

For each request to undertake transfer learning, the producer of MLTL may request to instantiate an MLTLRecipientJob on the MLTL recipient function or MLEntity, as described above with respect to FIG. 7, S703. The MLrecipientJob may also be instantiated by the MnS consumer to trigger the MLTL recipient to initiate an MLTL process with a specific MLTL producer, as described above with respect to FIG. 7, S709, S710.
Each MLTLRecipientJob is associated to at least one MLEntity on the MLTLrecipient function.
The MLTLRecipientJob may specify the MLTLSource which is the MLTL MnS producer to be used as the source of the MLTL process.
The MLTLRecipientJob may also specify the MLTLSourceMLEntity which is the MLEntity on the MLTL MnS producer to be used as the source of the MLTL process. This is needed e.g. if the MLTL process is triggered on the recipient MLTL function by the operator or a function that shall not be the recipient of the MLTL.
Each MLTLRecipientJob may specify details of the reporting that may be provided to the MnS consumer regarding the MLTL process.

The MLTLRecipientJob IOC includes the attributes shown in below Table 7:

| | Support | | | | |
|---|---|---|---|---|---|
| Attribute name | Qualifier | isReadable | isWritable | isInvariant | isNotifyable |
| MLTLRecipientJobId | M | T | F | F | F |
| recipientMLEntity | M | T | F | F | F |
| MLTLSource | O | T | F | F | F |
| MLTLSourceMLEntity | | | | | |

Further, datatype MLKnowledgeInfoReport represents the properties of MLKnowledgeInfoReport.

The MLKnowledgeInfoReport datatype includes one or more of the following attributes, as also illustrated in below Table 8:

For each MLKnowledgeInfoRequest, MLTL creates a new MLKnowledgeInfoReport to be shared with the consumer (MnS consumer, MLTL consumer). MLKnowledgeInfoReport is a datatype that is instantiated for each request for knowledge information (also referred to as request for information on available knowledge).
Each MLKnowledgeInfoReport may be associated to an MLEntity that indicates the source of the knowledge.
Each MLKnowledgeInfoReport is associated with one or more pieces of information on available shared knowledge (MLKnowledgeInfo) relevant to the consumer's MLKnowledgeInfoRequest.

TABLE 8

| | Support | | | | |
|---|---|---|---|---|---|
| Attribute name | Qualifier | isReadable | isWritable | isInvariant | isNotifyable |
| ReportId | M | T | F | F | F |
| MLEntity | O | T | F | F | F |
| KnowledgeInfos | M | T | F | F | F |

Further, datatype MLKnowledgeReport represents the properties of MLKnowledgeReport.

For each MLKnowledgeRequest, MLTL creates a new MLKnowledgeReport to be shared with the consumer (MnS consumer, MLTL consumer). MLKnowledgeReport is a datatype that is instantiated for each request for knowledge (also referred to as request for available knowledge).
Each MLKnowledgeReport is associated to a MLKnowledgeRequest.
Each MLKnowledgeReport is associated with one or more pieces of MLKnowledge relevant to the consumer's MLKnowledgeRequest.

The MLKnowledgeReport dataType includes one or more of the attributes shown in below Table 9:

| | Support | | | | |
|---|---|---|---|---|---|
| Attribute name | Qualifier | isReadable | isWritable | isInvariant | isNotifyable |
| MLKnowledgeReportID | M | T | F | F | F |
| MLKnowledgeRequestID | M | T | F | F | F |
| MLKnowledge | O | T | F | F | F |

Further, datatype MLKnowledgeInfo represents the properties of MLKnowledgeInfo.
Each MLKnowledgeInfo is associated to a knowledge variable.
Each MLKnowledgeInfo may specify a KnowledgeType that corresponds to the MLKnowledge available.
Each MLKnowledgeInfo specifies one or more KnowledgeNames related to the Variable and KnowledgeType specified above.
For some KnowledgeNames, the MLKnowledgeInfo may specify certain KnowlegeParameters through one or more KnowlegeParametersSets if needed. KnowlegeParametersSets is a list of parameter-value combinations that are applicable to the specific MLKnowledge.

The MLKnowledgeInfo datatype includes one or more of the attributes shown in below Table 10:

| | Support | | | | |
|---|---|---|---|---|---|
| Attribute name | Qualifier | isReadable | isWritable | isInvariant | isNotifyable |
| MLKnowledgeInfoId | M | T | F | F | F |
| Variable | M | T | F | F | F |
| KnowledgeType | O | T | F | F | F |
| KnowledgeName | M | T | F | F | F |
| KnowlegeParametersSets | M | T | T | F | T |

Further, datatype MLKnowledge represents the properties of MLKnowledge.
Each MLKnowledge is associated to a knowledge variable.
Each MLKnowledge may specify a KnowledgeType that corresponds to the MLKnowledge.
Each MLKnowledge specifies one or more KnowledgeNames related to the Variable and KnowledgeType specified above.
For some KnowledgeNames, the MLKnowledge may specify certain KnowlegeParameters if needed. KnowlegeParameters is a list of parameter-value combinations of PredictorArray and ResponseArray holding the actual values. The MLKnowledge dataType includes one or more of the attributes shown in below Table 11:

| | Support | | | | |
|---|---|---|---|---|---|
| Attribute name | Qualifier | isReadable | isWritable | isInvariant | isNotifyable |
| Variable | M | T | F | F | F |
| KnowledgeType | O | T | F | F | F |
| KnowledgeName | M | T | F | F | F |
| KnowlegeParameters | CM | T | T | F | T |
| PredictorArray | M | T | T | F | T |
| ResponseArray | M | T | T | F | T |

The procedures for discovering and sharing MLKnowledge or for executing ML transfer learning as described above may be implemented using standardized operations in SA5 combined with the above-described information models. According to the implementation example, the process of discovering MLKnowledge is implemented as illustrated by FIG. 10.

FIG. 10 illustrates a standards-based implementation of the procedure of discovering shared knowledge. At S1001, an MLTL consumer (MLTL consumer 1, e.g. operator) may request information on available shared knowledge offered by an MLTL producer (e.g. MLEntity or ML function/ML-enabled function), using a createMOI operation for an MLKnowledgeInfoRequest. The request (MLKnowledgeInfoRequest) for information on available knowledge may state the variable for which knowledge is desired, as described above with respect to the types of knowledge, and one or more of the types of knowledge (KnowledgeType). It may also include the MLEntity whose knowledge is needed, e.g. in cases where the ML function has more than one MLEntity.

At S1002, the MLTL producer instantiates an MLKnowledgeInfoRequest object.

At S1003, the MLTL producer writes available knowledge into the MLKnowledgeInfoRequest object.

At S1004, the MLTL producer may then report and provide information on available shared knowledge based on the request received in S1001 from the MLTL Consumer (MLTL consumer 1, e.g. operator). The MLTL producer may report to the MLTL consumer 1 or to an MLTL consumer 2, e.g. an MLEntity or ML function/ML-enabled function indicated in the request received in S1001, using a notifyMOIAttribteChanges notification emitted by the MLKnowledgeInfoRequest object instantiated on the MLTL producer, the notification emitted when the MLTL producer writes the available values into the MLKnowledgeInfoRequest object.

Alternatively, at S1005, the MLTL producer publishes its available knowledge to a shared repository (MLKnowledge Repository, KnowledgeRepo) from where the knowledge can be discovered and requested by any authorized consumer.

Subsequent to the publication, at S1006, the MLTL consumer (MLTL consumer 1, e.g. operator) may request from the repository information on available shared knowledge generated or provided by a specific MLTL producer, using a createMOI operation for an MLKnowledgeInfoRequest. Since multiple sources may publish their knowledge on the repository, the request (MLKnowledgeInfoRequest) has to state the MLTL producer whose knowledge is required, besides stating the variable, the MLEntity and the knowledge types.

At S1007, the MLKnowledge Repository instantiates an MLKnowledgeInfoRequest object.

At S1008, the MLKnowledge Repository writes available knowledge into the MLKnowledgeInfoRequest object.

At S1009, the MLKnowledge Repository may then report and provide information on available shared knowledge based on the request received in S1006 from the MLTL Consumer (MLTL consumer 1, e.g. operator). The MLKnowledge Repository may report to the MLTL consumer 1 or to an MLTL consumer 2, e.g. an MLEntity or ML function/ML-enabled function indicated in the request received in S1009, using a notifyMOIAttribteChanges notification emitted by the MLKnowledgeInfoRequest object instantiated on the MLKnowledge Repository, the notification emitted when the MLKnowledge Repository writes the available values into the MLKnowledgeInfoRequest object.

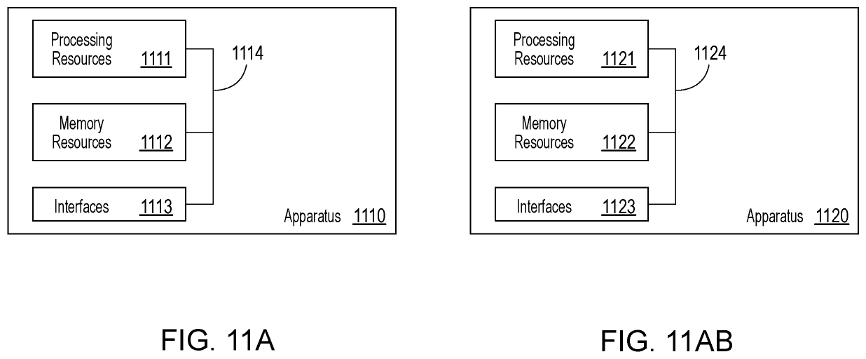

Finally, reference is made to FIGS. 11A and 11B illustrating a simplified block diagram of apparatuses 1110, 1120 that are suitable for use in practicing at least some example embodiments. According to an example embodiment, the process 1 of FIG. 4A is implemented by the apparatus 1110, and the process 2 of FIG. 4B is implemented by the apparatus 1120.

The apparatuses 1110, 1120 comprise processing resources (e.g. processing circuitry) 1111, 1121, memory resources (e.g. memory circuitry) 1112, 1122 and interfaces (e.g. interface circuitry) 1113, 1123, which are coupled via a wired or wireless connection 1114, 1124.

According to an example embodiment, the memory resources 1112, 1122 are of any type suitable to the local technical environment and are implemented using any suitable data storage technology, such as semiconductor based memory devices, magnetic memory devices and systems, optical memory devices and systems, fixed memory and removable memory. The processing resources 1111, 1121 are of any type suitable to the local technical environment, and include one or more of general purpose computers, special purpose computers, microprocessors, digital signal processors (DSPs) and processors based on a multi core processor architecture, as non-limiting examples.

According to an example embodiment, the memory resources 1112, 1122 comprise one or more non-transitory computer-readable storage media which store one or more programs that when executed by the processing resources 1111, 1121 cause the apparatuses 1110, 1120 to function as MnS producer/data repository or MnS consumer, as described above.

Further, as used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

The term “non-transitory”, as used herein, is a limitation of the medium itself (i.e., tangible, not a signal) as opposed to a limitation on data storage persistency (e.g., RAM vs. ROM).

It is noted that, as used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

According to at least some example embodiments, an apparatus (e.g. apparatus 1110 shown in FIG. 11A) for use by a management service producer or data repository of a communication network is provided.

The apparatus comprises means for providing at least one of the following: information about knowledge available for sharing, or knowledge available for sharing, wherein the apparatus further comprises means for executing a transfer learning process for sharing at least part of the knowledge available for sharing.

According to at least some example embodiments, the apparatus further comprises means for reporting on the information about the knowledge available for sharing, based on a request for information on available knowledge.

According to at least some example embodiments, the apparatus further comprises means for executing the transfer learning process by reporting on at least part of the knowledge available for sharing, based on a request for available knowledge.

According to at least some example embodiments, the apparatus further comprises means for executing the transfer learning process by reporting on at least part of the knowledge available for sharing, based on a request for executing the transfer learning process.

According to at least some example embodiments, the apparatus further comprises means for receiving the request for information on available knowledge from a management service consumer of the communication network and reporting, to the authorized management service consumer, on the information about the knowledge available for sharing.

According to at least some example embodiments, the apparatus further comprises means for receiving the request for available knowledge from a management service consumer of the communication network and executing the transfer learning process by reporting, to the authorized management service consumer, on the at least part of the knowledge available for sharing.

According to at least some example embodiments, the apparatus further comprises means for receiving the request for information on available knowledge from a management service consumer of the communication network and reporting, to an ML entity or ML-enabled function of the communication network, on the information about the knowledge available for sharing.

According to at least some example embodiments, the apparatus further comprises means for receiving the request for available knowledge from a management service consumer of the communication network and executing the transfer learning process by reporting, to an ML entity or ML-enabled function of the communication network, on the at least part of the knowledge available for sharing.

According to at least some example embodiments, the apparatus further comprises means for receiving the request for executing the transfer learning process from a management service consumer of the communication network and executing the transfer learning process by reporting, to an ML entity or ML-enabled function of the communication network, on the at least part of the knowledge available for sharing.

According to at least some example embodiments, the request for information on available knowledge specifies the ML entity or ML-enabled function.

According to at least some example embodiments, the request for available knowledge specifies the ML entity or ML-enabled function.

According to at least some example embodiments, the request for executing the transfer learning process specifies the ML entity or ML-enabled function.

According to at least some example embodiments, the request for information on available knowledge specifies a set of criteria for providing the information about the knowledge available for sharing.

According to at least some example embodiments, the request for available knowledge specifies criteria for providing the knowledge available for sharing.

According to at least some example embodiments, the request for executing the transfer learning process specifies criteria for providing the knowledge available for sharing.

According to at least some example embodiments, the request for information on available knowledge specifies at least one of the following: a task related to the knowledge, a domain related to the knowledge, a context related to the knowledge, or a network problem.

According to at least some example embodiments, the request for available knowledge specifies at least one of the following: a task related to the knowledge, a domain related to the knowledge, a context related to the knowledge, or a network problem.

According to at least some example embodiments, the request for executing the transfer learning process specifies at least one of the following: a task related to the knowledge, a domain related to the knowledge, a context related to the knowledge, or a network problem.

According to at least some example embodiments, the apparatus further comprises means for controlling the transfer learning process based on a command, from the authorized service management consumer, with respect to the request for available knowledge or the request for executing transfer learning.

According to at least some example embodiments, the apparatus further comprises means for controlling the transfer learning process based on content of the request for available knowledge or the request for executing transfer learning, adapted by the authorized service management consumer.

According to at least some example embodiments, for executing the transfer learning process, the apparatus further comprises means for adapting the knowledge into a format sharable with the ML entity or ML-enabled function or a format sharable with a management service consumer of the communication network.

According to at least some example embodiments, for executing the transfer learning process, the apparatus further comprises means for reporting on the at least part of the knowledge in a one-time transmission.

According to at least some example embodiments, for executing the transfer learning process, the apparatus further comprises means for reporting on the at least part of the knowledge by several transmissions of pieces or subsets of the at least part of the knowledge according to a frequency specified in a request for available knowledge or in a request for executing the transfer learning process.

According to at least some example embodiments, the knowledge comprises different types of knowledge, wherein the types comprise at least one of the following: rules, statistics, statistical distributions, statistical correlations, regressions, classifications, neural network models, neural network model portions, or clustering.

According to at least some example embodiments, the apparatus further comprises means for registering the knowledge available for sharing in the data repository.

According to at least some example embodiments, the apparatus further comprises means for publishing the knowledge available for sharing in the data repository.

According to at least some example embodiments, the means comprises at least one processor, and at least one memory storing instructions that, when executed by the at least one processor, cause the performance of the apparatus.

According to at least some example embodiments, an apparatus (e.g. apparatus 1120 shown in FIG. 11B) for use by a management service consumer of a communication network is provided.

The apparatus comprises means for generating at least one of the following: a request for information on available knowledge from a management service producer or data repository of the communication network, a request for available knowledge from a management service producer or data repository of the communication network, or a request for executing a transfer learning process between a management service producer or data repository of the communication network and an ML entity or ML-enabled function of the communication network, wherein the apparatus further comprises means for managing the request for available knowledge or the request for executing the transfer learning process, and/or means for adapting content of the request for available knowledge or the request for executing the transfer learning process.

According to at least some example embodiments, the apparatus further comprises means for specifying, in the request for information on available knowledge, an ML entity or ML-enabled function for receiving a report, from the management service producer or data repository, on information about knowledge available for sharing.

According to at least some example embodiments, the apparatus further comprises means for specifying, in the request for available knowledge, an ML entity or ML-enabled function for receiving a report, from the management service producer or data repository, on at least part of the knowledge available for sharing.

According to at least some example embodiments, the apparatus further comprises means for specifying, in the request for executing the transfer learning process, the ML entity or ML-enabled function for receiving a report, from the management service producer or data repository, on at least part of the knowledge available for sharing.

According to at least some example embodiments, the apparatus further comprises means for specifying, in the request for information on available knowledge, a set of criteria for providing information about knowledge available for sharing.

According to at least some example embodiments, the apparatus further comprises means for specifying, in the request for available knowledge, criteria for providing the knowledge available for sharing.

According to at least some example embodiments, the apparatus further comprises means for specifying, in the request for executing the transfer learning process, criteria for providing the knowledge available for sharing.

According to at least some example embodiments, the apparatus further comprises means for specifying, in the request for information on available knowledge, at least one of the following: a task related to the knowledge, a domain related to the knowledge, a context related to the knowledge, or a network problem.

According to at least some example embodiments, the apparatus further comprises means for specifying, in the request for available knowledge, at least one of the following: a task related to the knowledge, a domain related to the knowledge, a context related to the knowledge, or a network problem.

According to at least some example embodiments, the apparatus further comprises means for specifying, in the request for executing the transfer learning process, at least one of the following: a task related to the knowledge, a domain related to the knowledge, a context related to the knowledge, or a network problem.

According to at least some example embodiments, the apparatus further comprises means for specifying, in the request for executing the transfer learning process, the management service producer.

According to at least some example embodiments, the apparatus further comprises means for specifying, in the request for information on available knowledge, a description of knowledge required.

According to at least some example embodiments, the apparatus further comprises means for specifying, in the request for available knowledge, a description of the at least part of the knowledge.

According to at least some example embodiments, the apparatus further comprises means for specifying, in the request for executing the transfer learning process, a description of the at least part of the knowledge.

According to at least some example embodiments, the apparatus further comprises means for specifying, in the request for information on available knowledge, a variable and a knowledge type.

According to at least some example embodiments, the apparatus further comprises means for specifying, in the request for available knowledge, a variable and at least one of a knowledge name or a knowledge type.

According to at least some example embodiments, the apparatus further comprises means for specifying, in the request for executing the transfer learning process, a variable and at least one of a knowledge name or a knowledge type.

According to at least some example embodiments, the apparatus further comprises means for specifying, in the request for available knowledge, a frequency for reporting the available knowledge.

According to at least some example embodiments, the apparatus further comprises means for specifying, in the request for executing the transfer learning process, a frequency for reporting the available knowledge.

According to at least some example embodiments, for the managing, the apparatus comprises means for suspending, re-activating, or cancelling the request for available knowledge.

According to at least some example embodiments, for the managing, the apparatus comprises means for starting, suspending, or restarting the request for executing the transfer learning process.

According to at least some example embodiments, for the adapting, the apparatus comprises means for adjusting description of knowledge for the request for available knowledge.

According to at least some example embodiments, for the adapting, the apparatus comprises means for adjusting conditions or characteristics of the transfer learning process for the request for executing the transfer learning process.

According to at least some example embodiments, the apparatus further comprises means for initiating the transfer learning process by transmitting the request for executing the transfer learning process to the management service producer.

According to at least some example embodiments, the apparatus further comprises means for initiating the transfer learning process by transmitting the request for executing the transfer learning process to the ML entity or ML-enabled function.

According to at least some example embodiments, the means comprises at least one processor, and at least one memory storing instructions that, when executed by the at least one processor, cause the performance of the apparatus.

It is to be understood that the above description is illustrative and is not to be construed as limiting the subject matter described herein. Various modifications and applications may occur to those skilled in the art without departing from the true spirit and scope as defined by the appended claims.

1. A method for use by a management service producer or data repository of a communication network, the method comprising:
providing at least one of the following:
information about knowledge available for sharing; or
knowledge available for sharing,
wherein the method further comprises:
executing a transfer learning process for sharing at least part of the knowledge available for sharing.

2. The method of claim 1, further comprising at least one of the following:
reporting on the information about the knowledge available for sharing, based on a request for information on available knowledge;
executing the transfer learning process by reporting on at least part of the knowledge available for sharing, based on a request for available knowledge; or executing the transfer learning process by reporting on at least part of the knowledge available for sharing, based on a request for executing the transfer learning process.

3. The method of claim 2, further comprising at least one of the following:
receiving the request for information on available knowledge from a management service consumer of the communication network and reporting, to the authorized management service consumer, on the information about the knowledge available for sharing;
receiving the request for available knowledge from a management service consumer of the communication network and executing the transfer learning process by reporting, to the authorized management service consumer, on the at least part of the knowledge available for sharing;
receiving the request for information on available knowledge from a management service consumer of the communication network and reporting, to an ML entity or ML-enabled function of the communication network, on the information about the knowledge available for sharing;
receiving the request for available knowledge from a management service consumer of the communication network and executing the transfer learning process by reporting, to an ML entity or ML-enabled function of the communication network, on the at least part of the knowledge available for sharing; or
receiving the request for executing the transfer learning process from a management service consumer of the communication network and executing the transfer learning process by reporting, to an ML entity or ML-enabled function of the communication network, on the at least part of the knowledge available for sharing.

4. The method of claim 2, wherein at least one of the following applies:
the request for information on available knowledge specifies the ML entity or ML-enabled function;
the request for available knowledge specifies the ML entity or ML-enabled function;
the request for executing the transfer learning process specifies the ML entity or ML-enabled function;
the request for information on available knowledge specifies a set of criteria for providing the information about the knowledge available for sharing;
the request for available knowledge specifies criteria for providing the knowledge available for sharing; or
the request for executing the transfer learning process specifies criteria for providing the knowledge available for sharing.

5. The method of claim 2, wherein at least one of the following applies:
the request for information on available knowledge specifies at least one of the following: a task related to the knowledge, a domain related to the knowledge, a context related to the knowledge, or a network problem;
the request for available knowledge specifies at least one of the following: a task related to the knowledge, a domain related to the knowledge, a context related to the knowledge, or a network problem; or
the request for executing the transfer learning process specifies at least one of the following: a task related to the knowledge, a domain related to the knowledge, a context related to the knowledge, or a network problem.

6. The method of claim 2, further comprising at least one of the following:
controlling the transfer learning process based on a command, from the authorized service management consumer, with respect to the request for available knowledge or the request for executing transfer learning; or
controlling the transfer learning process based on content of the request for available knowledge or the request for executing transfer learning, adapted by the authorized service management consumer.

7. The method of claim 1, wherein executing the transfer learning process comprises:
adapting the knowledge into a format sharable with the ML entity or ML-enabled function or a format sharable with a management service consumer of the communication network.

8. The method of claim 1, wherein executing the transfer learning process comprises at least one of the following:
reporting on the at least part of the knowledge in a one-time transmission; or
reporting on the at least part of the knowledge by several transmissions of pieces or subsets of the at least part of the knowledge according to a frequency specified in a request for available knowledge or in a request for executing the transfer learning process.

9. The method of any one of claims 1, wherein the knowledge comprises different types of knowledge, wherein the types comprise at least one of the following: rules, statistics, statistical distributions, statistical correlations, regressions, classifications, neural network models, neural network model portions, or clustering.

10. The method of claim 1, further comprising:
registering the knowledge available for sharing in the data repository; or
publishing the knowledge available for sharing in the data repository.

11. A method for use by a management service consumer of a communication network, the method comprising at least one of the following:
generating a request for information on available knowledge from a management service producer or data repository of the communication network;
generating a request for available knowledge from a management service producer or data repository of the communication network; or
generating a request for executing a transfer learning process between a management service producer or data repository of the communication network and an ML entity or ML-enabled function of the communication network,
wherein the method further comprises at least one of the following:
managing the request for available knowledge or the request for executing the transfer learning process; or
adapting content of the request for available knowledge or the request for executing the transfer learning process.

12. The method of claim 11, wherein at least one of the following applies:
specifying, in the request for information on available knowledge, an ML entity or ML-enabled function for receiving a report, from the management service producer or data repository, on information about knowledge available for sharing;
specifying, in the request for available knowledge, an ML entity or ML-enabled function for receiving a report, from the management service producer or data repository, on at least part of the knowledge available for sharing;
specifying, in the request for executing the transfer learning process, the ML entity or ML-enabled function for receiving a report, from the management service producer or data repository, on at least part of the knowledge available for sharing;
specifying, in the request for information on available knowledge, a set of criteria for providing information about knowledge available for sharing;
specifying, in the request for available knowledge, criteria for providing the knowledge available for sharing;
specifying, in the request for executing the transfer learning process, criteria for providing the knowledge available for sharing;
specifying, in the request for information on available knowledge, at least one of the following: a task related to the knowledge, a domain related to the knowledge, a context related to the knowledge, or a network problem;
specifying, in the request for available knowledge, at least one of the following: a task related to the knowledge, a domain related to the knowledge, a context related to the knowledge, or a network problem;
specifying, in the request for executing the transfer learning process, at least one of the following: a task related to the knowledge, a domain related to the knowledge, a context related to the knowledge, or a network problem;
specifying, in the request for executing the transfer learning process, the management service producer;
specifying, in the request for information on available knowledge, a description of knowledge required;
specifying, in the request for available knowledge, a description of the at least part of the knowledge;
specifying, in the request for executing the transfer learning process, a description of the at least part of the knowledge;
specifying, in the request for information on available knowledge, a variable and a knowledge type;
specifying, in the request for available knowledge, a variable and at least one of a knowledge name or a knowledge type;
specifying, in the request for executing the transfer learning process, a variable and at least one of a knowledge name or a knowledge type;
specifying, in the request for available knowledge, a frequency for reporting the available knowledge; or
specifying, in the request for executing the transfer learning process, a frequency for reporting the available knowledge.

13. The method of claim 11, wherein the managing comprises at least one of the following:
suspending, re-activating, or cancelling the request for available knowledge; or
starting, suspending, or restarting the request for executing the transfer learning process, and
wherein the adapting comprises at least one of the following:
adjusting description of knowledge for the request for available knowledge; or
adjusting conditions or characteristics of the transfer learning process for the request for executing the transfer learning process.

14. The method of claim 11, further comprising:
initiating the transfer learning process by transmitting the request for executing the transfer learning process to the management service producer; or
initiating the transfer learning process by transmitting the request for executing the transfer learning process to the ML entity or ML-enabled function.

15. An apparatus comprising at least one processor and at least one memory including computer program code, the at least one memory and the computer program code configured to, with the at least one processor, cause the apparatus at least to perform at least:
providing at least one of the following: information about knowledge available for sharing, or knowledge available for sharing; and
executing a transfer learning process for sharing at least part of the knowledge available for sharing.

16. The apparatus of claim 15, wherein the at least one memory and the computer program code are further configured to, with the at least one processor, cause the apparatus at least to perform at least one of the following:
reporting on the information about the knowledge available for sharing, based on a request for information on available knowledge;
executing the transfer learning process by reporting on at least part of the knowledge available for sharing, based on a request for available knowledge; or
executing the transfer learning process by reporting on at least part of the knowledge available for sharing, based on a request for executing the transfer learning process.

17. The method of claim 16, wherein the at least one memory and the computer program code are further configured to, with the at least one processor, cause the apparatus at least to perform at least one of the following:
receiving the request for information on available knowledge from a management service consumer of the communication network and reporting, to the authorized management service consumer, on the information about the knowledge available for sharing;
receiving the request for available knowledge from a management service consumer of the communication network and executing the transfer learning process by reporting, to the authorized management service consumer, on the at least part of the knowledge available for sharing;
receiving the request for information on available knowledge from a management service consumer of the communication network and reporting, to an ML entity or ML-enabled function of the communication network, on the information about the knowledge available for sharing;
receiving the request for available knowledge from a management service consumer of the communication network and executing the transfer learning process by reporting, to an ML entity or ML-enabled function of the communication network, on the at least part of the knowledge available for sharing; or
receiving the request for executing the transfer learning process from a management service consumer of the communication network and executing the transfer learning process by reporting, to an ML entity or ML-enabled function of the communication network, on the at least part of the knowledge available for sharing.

18. The apparatus of claim 16, wherein at least one of the following applies:
the request for information on available knowledge specifies the ML entity or ML-enabled function;
the request for available knowledge specifies the ML entity or ML-enabled function;
the request for executing the transfer learning process specifies the ML entity or ML-enabled function;
the request for information on available knowledge specifies a set of criteria for providing the information about the knowledge available for sharing;
the request for available knowledge specifies criteria for providing the knowledge available for sharing; or
the request for executing the transfer learning process specifies criteria for providing the knowledge available for sharing.

19. The apparatus of claim 16, wherein at least one of the following applies:
the request for information on available knowledge specifies at least one of the following: a task related to the knowledge, a domain related to the knowledge, a context related to the knowledge, or a network problem;
the request for available knowledge specifies at least one of the following: a task related to the knowledge, a domain related to the knowledge, a context related to the knowledge, or a network problem; or
the request for executing the transfer learning process specifies at least one of the following: a task related to the knowledge, a domain related to the knowledge, a context related to the knowledge, or a network problem.

20. The apparatus of claim 16, wherein the at least one memory and the computer program code are further configured to, with the at least one processor, cause the apparatus at least to perform at least one of the following:
controlling the transfer learning process based on a command, from the authorized service management consumer, with respect to the request for available knowledge or the request for executing transfer learning; or
controlling the transfer learning process based on content of the request for available knowledge or the request for executing transfer learning, adapted by the authorized service management consumer.
